(19) United States
(12) Patent Application Publication
(10) Pub. No.: US 2013/0198529 A1
(43) Pub. Date: Aug. 1, 2013

(54) SAMPLE CARRIER UNIT HAVING SAMPLE DATA ENCRYPTION AND METHOD FOR USE THEREOF

(71) Applicants: Guenter R. Fuhr, Berlin (DE); Heiko Zimmermann, Frankfurt am Main (DE); Haiko Wick, Saarwellingen-Reisbach (DE); Frank Ihmig, Sulzbach (DE)

(72) Inventors: Guenter R. Fuhr, Berlin (DE); Heiko Zimmermann, Frankfurt am Main (DE); Haiko Wick, Saarwellingen-Reisbach (DE); Frank Ihmig, Sulzbach (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 13/878,218

(22) PCT Filed: Oct. 10, 2011
(86) PCT No.: PCT/EP11/05060

§ 371 Date: Apr. 6, 2013

(30) Foreign Application Priority Data
Oct. 18, 2010 (DE) 10 2010 048 784.8

(51) Int. Cl. G06F 21/60

(52) U.S. Cl. CPC G06F 21/602
USPC 713/189

(57) ABSTRACT

A sample carrier unit (100), in particular for biological samples, is described which comprises a sample uptake unit (10) which is equipped for taking up at least one sample, a data storage unit (20) which is equipped for the storage of sample data that relate to the at least one sample, and to a key storage unit (30) having at least one key store (31, 32, 33), wherein the key storage unit (30) is equipped for storing key data in the at least one key store (31, 32, 33). At least one key store (31, 32, 33) of the key storage unit (30) can be arranged so as to be separable from the sample carrier unit (100). In addition, a data processing unit (200) which is configured for coupling to the sample carrier unit (100) and a method for processing sample data are described, which sample data are encrypted using at least one cryptological key which is stored in the key storage unit (30).

The invention relates to a sample carrier device, in particular for biological samples, with a sample receiving device that is adapted to receive at least one sample, and with a data storage device that is adapted to save data that relates to at least one sample. In addition, the invention relates to a data processing device that is adapted for data exchange with the sample carrier device. In addition, the invention is a method for processing sample data, in particular from biological samples, while using the sample carrier device. Applications of the invention are available with handling samples, in particular, biological samples, e.g. with extraction, processing, storage and/or preservation of biological samples. The invention allows, in particular, reversible or irreversible anonymization and/or authentication of samples.

With the development of biosciences such as biochemistry, biomedicine or biotechnology and medical diagnostics, there is an increasing need for biological samples (biological organisms or parts thereof, e.g. tissue, tissue parts, body fluids, cells or cell components) and the associated sample data are generated or processed while extracting, processing, storing or preserving the samples. Application scenarios for biological samples differ with regard to the number of samples, duration of use, duration of storage and/or the complexity of the sample data, wherein there are important aspects in the safety and reproduction capability of the handling of samples, e.g. maintaining certain storage conditions, identifying samples and traceability of samples with regard to the source of the sample or application conditions.

It is generally known to store sample data, e.g. for identification or documentation purposes in a data storage which is directly and physically connected to the sample (e.g. U.S. Pat. No. 6,931,864). Sample carrier devices that physically connect a sample receiving device and a data storage device allow a complete and unmistakable description of the sample independent of its current location or database connection. The connection of the sample data with the sample can, however, also be disadvantageous if sample data or parts of are to be only limitedly available.

Thus, sample data in human medicine can contain person-related data about a donor or a patient, wherein this data is significant for handling or evaluating the samples but, however, for ethical or legal reasons, it must be treated with strict confidentiality. For example, samples must be reliably anonymized before they are transferred to research institutes or laboratories in order to protect the personal privacy rights of the donor. For laboratory analyses or clinical studies, however, there may be an interest in reconnecting e.g. measuring results retroactively with person-related data, for instance if, after a longer storage period, new medical knowledge allows for an improved treatment of the affected person. There is therefore interest in irreversibly anonymizing or reversibly anonymizing (or: pseudonymisation) samples.

It is known from practice, for anonymizing sample data, not to store all of the complete person-related data, but instead, to store only information for identification. To reversibly anonymize the samples, the identification information can be stored separately from the sample, manually or electronically with the corresponding person-related data. Additional data that is gathered after taking the sample can also be anonymized and stored separately from the sample. According to another known approach from practice, the data can be anonymized by deleting person-related data or software-based suppression of person-related data when reading sample data.

The conventional anonymization methods have a number of disadvantages that affect, in particular, the permanent storage of samples, e.g. in a cryopreserved state. Thus, the conventional use of the identification information requires a separation of information from the sample, thus a complete and unmistakable description and documentation of the sample is no longer guaranteed. The assignment of the identification information to the separately stored data (so-called “mapping”) which, if needed, has to be realized using manual data processing, results in a high work expenditure and high risk of error. The reliable restoration of information in the reversible anonymization cannot be securely guaranteed by mapping in long-term storage, e.g. for years. Finally, the reliable, physical deletion of electronically stored information requires high expenditure, which has a negative effect, in particular, when handling a large number of samples.

From DE 102 06 396 A1, it is known that in addition to a patient's sample data, biometric key data is also stored that is specific to the patient. The biometric key data is acquired from the sample and stored together with the sample data in a data set, however anonymization of the sample data is not possible. Additional methods for processing biometric data are known from U.S. 2004/0162987 A1 and WO 2005/064325 A2, wherein, however, they also have disadvantages with regard to the options for reliable anonymization or pseudonymization of data.

The aforementioned disadvantages not only arise in human medicine, but also in other applications for biological or non-biological samples when, e.g. samples are to be exchanged between different laboratories for testing purposes and associated sample data needs to be kept confidential.

The objective of the invention is to provide an improved sample carrier device that is adapted for receiving samples and storing data with which disadvantages of conventional sample carrier devices are avoided. The sample carrier device is to be suitable for an irreversible or reversible anonymization with less expenditure, more reliability and/or increased long-term stability. An additional objective of the invention is to provide a data processing device that is configured for coupling with the improved sample carrier device. The objective of the invention is also to provide an improved method for processing sample data by means of which disadvantages of conventional techniques are overcome.

The objectives of the invention are solved by a sample carrier device, a data processing device and a method, resp., with the features of the independent claims. Advantageous embodiments of the invention result from the dependent claims.

According to a first aspect of the invention, the aforementioned objective is solved by a sample carrier device, which is provided with a sample receiving device and a data storage device. The sample receiving device is configured to receive at least one sample, in particular at least one biological sample. It comprises at least one sample receptacle, e.g. in the form of a closable container or a carrier substrate. The data storage device is adapted for storing sample data, which relate to the at least one sample. The data storage device comprises at least one data storage (data memory) that is adapted for storing the sample data.

According to the invention, the sample carrier device is also provided with a key storage device that has at least one key storage (key memory). The key storage device and the data storage device are two components provided on the sample carrier device. The key storage device, which is provided as a separate component additionally to the data storage device, is adapted for storing key data in the at least one key storage. The key data comprises at least one cryptological key that can be used for cryptological data encryption, in particular for cryptological encryption of the sample data or a part thereof.

The cryptological encryption can comprise immediate encryption of sample data itself and/or encryption of additional data. When encrypting additional data, variants of the invention are provided in which the key is not directly stored in the key storage device, but information for generation or use of keys stored elsewhere. For example, the key storage device can be used to store information required to generate a temporary key (or so-called session key) with which the encrypted data can be decrypted. Furthermore, the key storage device can be used to store information which, supplemented by information on the recipient side (e.g. recipient's key), can be used for generating such a session key or for direct decryption. The key storage device can also be used to store a confidential, sample-specific number (PIN) or a password for encrypting or decrypting with the help of a key stored in the data storage device.

According to the invention, the sample data stored in the data storage device can be fully encrypted. Alternatively, it is possible to encrypt only parts of the sample data. For example, for applications in human medicine, the encryption can be limited to personal data (data that characterize the sample donor and/or features thereof). For other applications, the encryption can be limited to confidential data that is related e.g. to the composition of the sample or its creation. In the following, when reference is generally made to encrypting the sample data, this can refer to both variants for encrypting the complete sample data or a part of it.

Advantageously, with the sample carrier device according to the invention, a combination of at least one sample, associated sample data and key data is created, wherein the sample data is stored encrypted in the data storage device and, using the key data, can be decrypted and read. By storing the encrypted sample data, unauthorized access to the sample data can be prevented. The encryption allows for the at least one sample to be anonymized without deleting sample data or having to store it separately from the sample carrier device. Furthermore, advantageously, the anonymization and optional re-identification of samples is possible with high speed and very easy. The sample carrier device according to the invention is suitable for application with established data structures and with permanent processes, e.g. for handling and/or storing the samples for several years, in particular for cryopreservation of the samples.

According to a second aspect of the invention, a data processing device is provided that is configured for coupling with the sample carrier device in accordance with the first aspect of the invention. The data processing device comprises a read-write device with which the key data in the key storage device of the sample carrier device can be read and a cryptological processor, which is connected with the read-write device and which is configured to decrypt and/or encrypt sample data using the key data. The data processing device has a data connection e.g. via a wireless or wired interface via which the encrypted sample data can be saved to or read from the data storage device of the sample carrier device coupled with the data processing device.

Advantageously, with the data processing device a compact, structurable tool is created that is suitable for quickly storing and quickly reading encrypted data that is particularly suitable for automated handling of sample carrier devices.

According to a third aspect of the invention, a method for processing sample data is provided with which the sample carrier device in accordance with the aforementioned first aspect of the invention is used. According to the invention, the sample data or a part of it is encrypted using the key data, in particular the at least one cryptological key, which is contained in the key data and stored in the key storage device, and the encrypted sample data is stored in the data storage device of the sample carrier device. Advantageously, the method according to the invention can be combined with conventional methods for the primary generation of sample data and the further processing thereof, e.g. amending, reading, updating and monitoring.

According to a fourth aspect of the invention, a method is provided for authenticating a work station, e.g. within an area for sample processing in relation to a sample carrier device, e.g. by using a work station key for certain data sets, wherein the sample carrier device according to the aforementioned first aspect of the invention is used. At the work station, the data processing device in particular in accordance with the second aspect of the invention can be used as a reading device.

Furthermore, an authentication of a sample carrier device can be provided, wherein a signature key (“digital signature”) is stored. An asymmetrical method can be realized, wherein a sample source signs the sample in an area of sample generation with a private key that is known only to the sample source, and the signature can be verified with a public key.

Advantageously, according to the invention, the encrypted sample data can be protected from unauthorized access, although the key storage device with the key data at least when entering the sample in the sample carrier device and during the primary generation of sample data and, optionally, also during the further processing of the sample carrier device is fixedly connected with the sample carrier device. For example, the cryptological system on which the encryption and decryption of the sample data is based can work with an asymmetrical key, of which a first (public) portion is saved in the key storage device and a second (non-public) part is kept confidential by users of the sample carrier device. Alternatively, the cryptological system can work with a symmetrical key, wherein, however, the access to the cryptological key in the key storage device can be password protected.

Alternatively, according to a preferred and especially advantageous embodiment of the invention, it is possible to separate at least one key storage of the key storage device from the sample carrier device. In this embodiment of the invention, a physical separation of the at least one key storage from the sample carrier device, in particular from the sample receiving device, the data storage device and/or a housing thereof is provided, wherein a mechanical connection between the at least one key storage and the sample carrier device is interrupted.

The separation of the at least one key storage from the sample carrier device can be irreversible. In this variant, a predetermined breaking point is preferably provided at which the at least one key storage can be separated from the sample carrier device. Advantageously, the irreversible separation allows for fast and reliable anonymization (“one-way anonymization”) in such a way that the at least one key storage is separated from the sample carrier device, e.g., interrupted or cut off, and thus eventually damaged in an irreversible fashion. With this variant, however, a reversible anonymization can also be achieved if, after the separation of the at least one key storage, additional key data, e.g. at least one identification key and/or at least one master key remains stored in the key storage device. The additional key data can be used to reconstruct the at least one cryptological key as described below.

Alternatively, a reversible separability can be provided. With this variant, the at least one key storage can be attached releasably to a storage holder of the sample carrier device, wherein the storage holder is configured, e.g. for a plug, locking or screw connection of the at least one key storage to the sample carrier device.

Advantageously, there are no limitations with regard to the type of storage of key data in the key storage device. According to preferred variants of the invention, the at least one key storage can be adapted for electronic, optical and/or magnetic storage of the key data. Furthermore, the at least one key storage can be configured for a one-time storage of the key data (read only storage) or for multiple storages and/or changes to the key data (read-write storage).

If, according to a further preferred embodiment of the invention, the key storage device is configured for a wireless data connection with a reading or read-write device, in particular with the data processing device in accordance with the aforementioned second aspect of the invention, advantages for easy handling of the sample carrier device can result when storing or reading sample data.

According to a particularly preferred embodiment of the invention, the key storage device comprises at least one transponder (RFID circuit). The transponder comprises a transponder storage, with which the key storage is provided, and a resonance structure with which the wireless data connection with the read-write or reading device can be realized. Depending on the application of the invention and the design of the sample carrier device, the key storage device can comprise several transponders which each provide a key storage and can be read individually. To realize the aforementioned separability of the at least one key storage from the sample carrier device, the at least one transponder can be connected to the sample carrier device via a predetermined breaking point or a storage holder.

The use of a transponder for providing a key storage is not, however, absolutely necessary. Alternatively, the key storage can also be realized by a storage chip, e.g. a FLASH storage device, an optical storage device or even by a graphic code, such as a bar or dot code. In contrast to a storage chip, the transponder has the advantage of an energy supply integrated via the resonance structure of the transponder.

Although the provision of an individual key storage for receiving the at least one cryptological key and optional additional key data is sufficient for implementing the invention, providing several key storages can be advantageous for special applications of the invention. For instance, the sample data can have a data structure with different types of sample data (sample data types). The sample data types can each comprise e.g. information about the sample source (person-related data, donor data), information about the taking of the sample, information about the processing of the sample, information about the measured characteristics (measuring values) of the sample and/or information about the storage conditions (temperature profiles or similar). For each sample data type, a specific cryptological key can be stored in the key storage device. According to a preferred embodiment of the invention, in this case, several key storages are provided each of which being configured for saving a cryptological key for one of the sample data types. Advantageously, the anonymization can be realized specifically for individual sample data types.

Alternatively or additionally, the data storage device can comprise several storage areas which are physically separated from each other and are each configured to store one of the sample data types. In this case, each one of the key storages can be assigned to one of the storage areas.

The provision of several key storages can additionally be advantageous for storing different types of key data (key data types) separately, e.g. the at least one cryptological key or at least one partial key, the at least one identification key and the master key. This embodiment of the invention offers advantages with regard to a high level of flexibility when using different methods for anonymization and/or re-identification which are described in the following.

According to a first variant of the method according to the invention, one single cryptological key is stored in the key storage device with which the sample data is encrypted or decrypted. For reversible or irreversible anonymization of the sample, it can be provided that the key storage with the cryptological key correspondingly is separated from the sample carrier device for a certain anonymization period or permanently.

According to a modification of the first variant, different cryptological keys are stored, preferably in different key storages in the key storage device which are provided for encrypting different sample data types and/or different storage areas of the sample data storage device. For reversible or irreversible anonymization, corresponding key storages with the different cryptological keys can be temporarily or permanently separated from the sample carrier device.

According to a second variant of the method according to the invention, the at least one cryptological key is stored in the key storage device and additionally in a key database, which is separate from the sample carrier device and preferably connected to the data processing device in accordance with the aforementioned second aspect of the invention. Furthermore, at least one identification key is stored in the key storage device. The identification key comprises information with which the at least one cryptological key is identified in the key database, e.g. a storage address of the cryptological key in the key database. Alternatively or additionally, this information can also be stored in the data storage device, in particular as a further option for reversible anonymization. This way, the sample is then anonymized at most reversibly.

The at least one cryptologic key and the at least one identification key are stored in different key storages of the key storage device. To anonymize the sample, the at least one cryptological key can first be separated from the sample carrier device, wherein a temporary or permanent separation can be provided. In the second variant of the method according to the invention, the anonymization can also be reversed (re-identification) in the case of permanent separation of the at least one cryptological key from the sample carrier device. To this end, the at least one cryptological key is read from the key database using the at least one identification key and used for encryption or decryption of the sample data. If the at least one key storage with the at least one identification key is also separated from the sample carrier device, the at least one cryptological key in the key database can no longer be identified and read. In this case, the re-identification is excluded.

Advantageously, the application of the at least one identification key allows for a sample to be quickly and reliably, reversibly or irreversibly anonymized in such a way that only the at least one cryptological key or both the at least one cryptological key and the at least one identification key are separated from the sample carrier device.

According to a third variant of the method according to the invention, the at least one cryptological key is encrypted with a master key and saved in the data storage device of the sample carrier device. In this case, preferably, the at least one cryptological key is stored in at least one key storage of the key storage device and at most a part of the master key is stored in a further key storage of the key storage device. A further part of the master key can be stored in a source storage, which is separated from the sample carrier device, e.g. provided at the site the sample is generated.

In the third variant of the method according to the invention, sample data encrypting or decrypting with the at least one cryptological key can be provided in the non-anonymized state. If the at least one cryptological key is removed and the sample thus anonymized, a re-identification can be performed in such a way that the encrypted cryptological key can be read from the data storage device and decrypted with the master key. Subsequently, the decrypted cryptological key can be used for decrypting the sample data. If a part of the master key is stored separately from the sample carrier device, the re-identification can only be realized at the site where the part of the master key is stored. This can be advantageous if certain sample data should only be available at the site where the sample was generated, e.g. blood sampling from a donor.

Even when using the master key, an irreversible anonymization can be achieved by permanently separating the key storage with the part of the master key from the sample carrier device.

According to a further advantageous embodiment of the sample carrier device according to the invention, it can be provided for that each key storage bears a specific marking. The marking can indicate, for example, the function of the key storage or the type of the key data stored in the relevant key storage. Alternatively or additionally, the marking can be comprise an identification for assigning a key storage that has been removed with a sample, e.g. a sample identification (sample ID). An ID is necessary for new assignment in particular in case of temporal removing of the key storage. Alternatively, the sample ID could however also, additionally, be saved in the key storage.

Preferably, a visually perceivable marking, e.g. a color marking or a label of the key storage is provided. Through visual observation or optical detection, the key storage that was removed from the sample carrier device can easily be determined. Thus, it can easily be determined whether the sample was reversibly or irreversibly anonymized and/or which data areas in the data storage device are anonymized.

Further details and advantages of the invention will be described below with reference to the attached drawings. The figures show as follows:

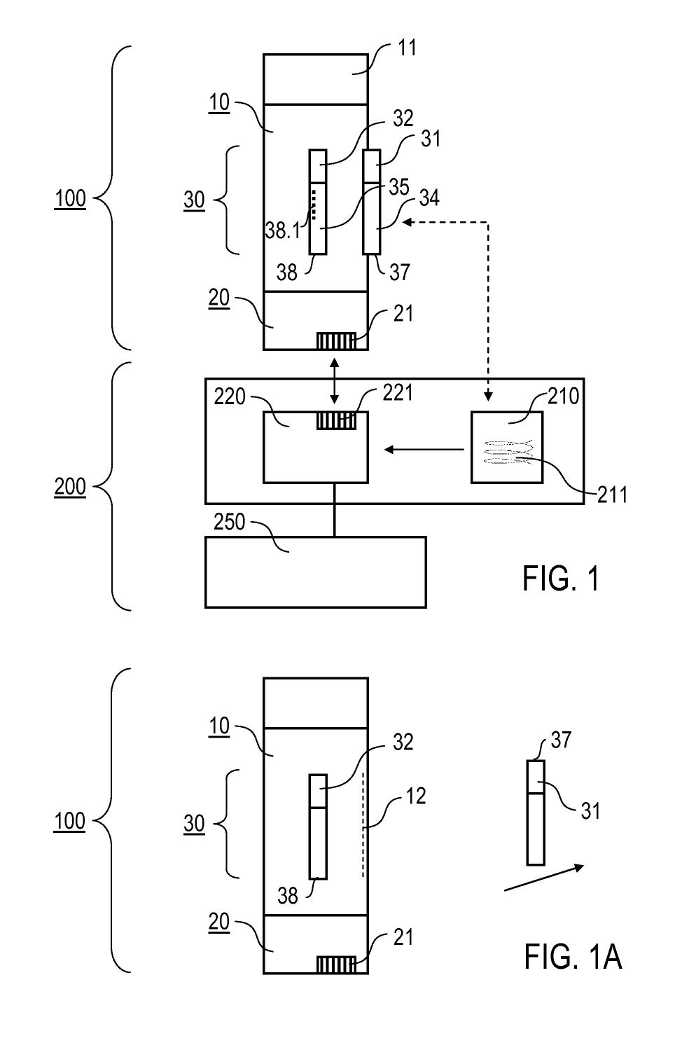

FIGS. 1 and 1A: a first embodiment of the sample carrier device and the data processing device according to the invention;

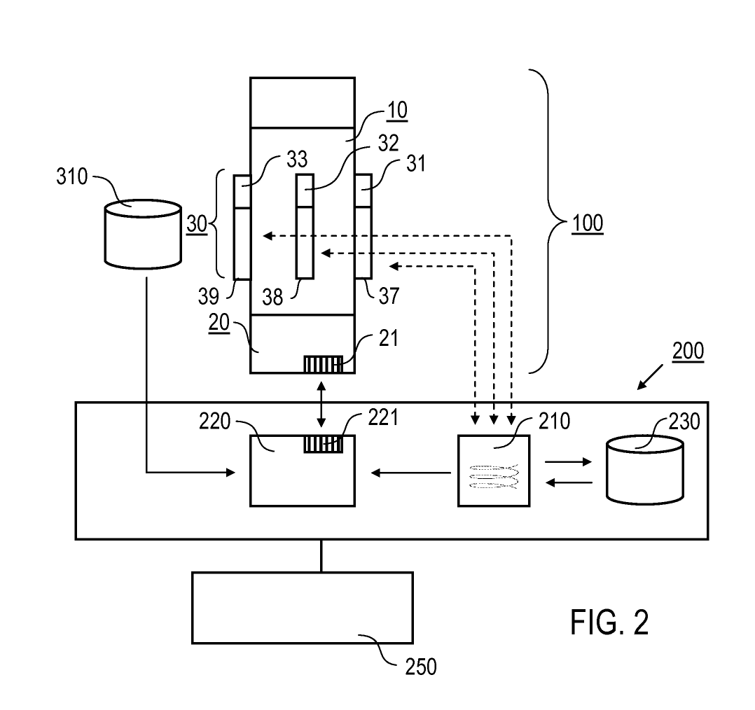

FIG. 2: features of further embodiments of the sample carrier device and the data processing device according to the invention;

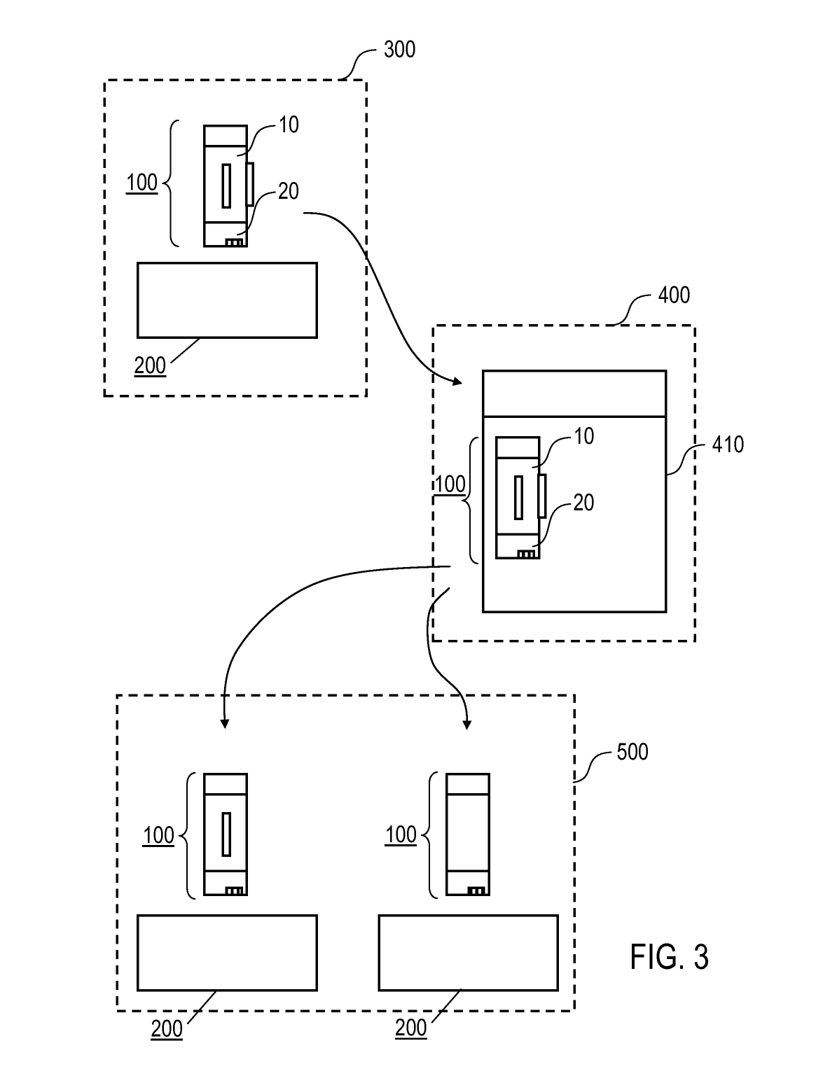

FIG. 3: a schematic overview of the generation, storage and distribution of samples and sample data;

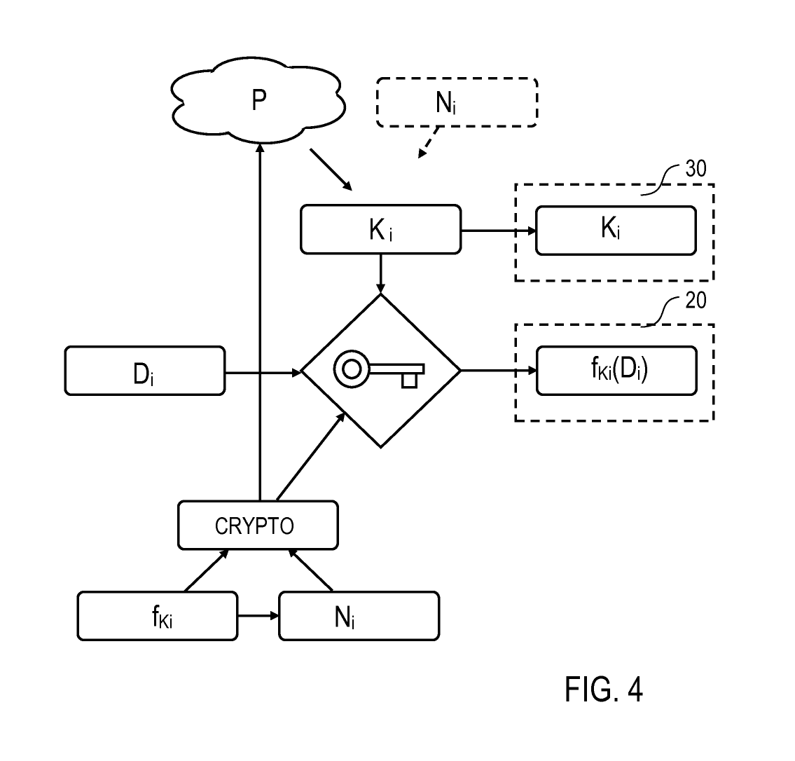

FIG. 4: a schematic overview representation of the cryptological encrypting of sample data provided according to the invention;

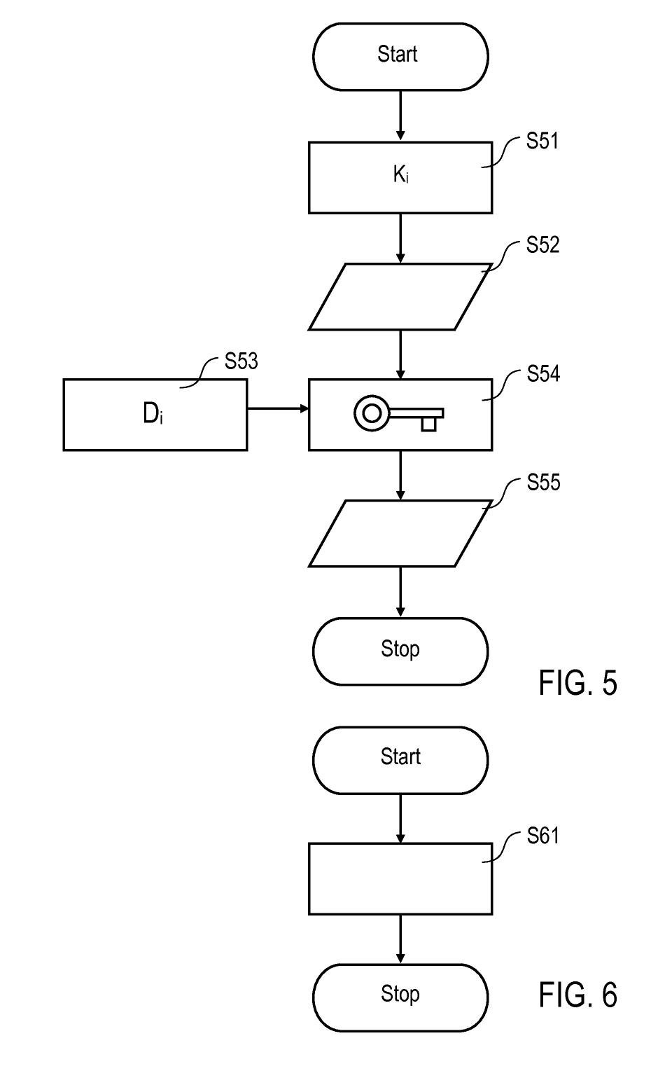

FIGS. 5 and 6: flow diagrams for illustrating a first variant of the method according to the invention and an irreversible anonymization of a sample;

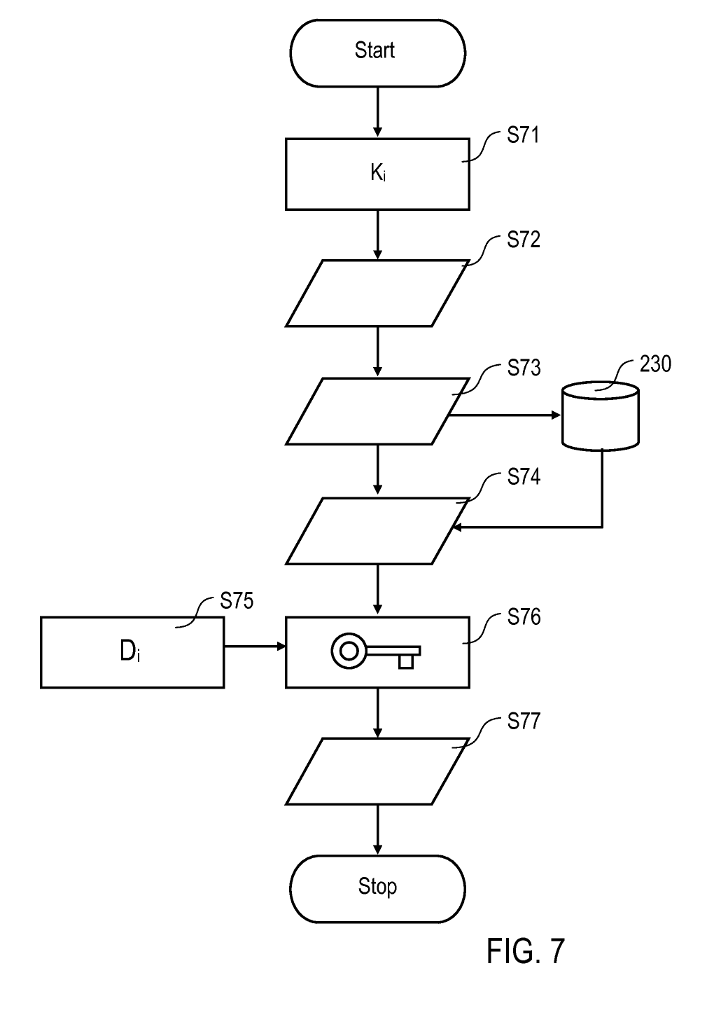

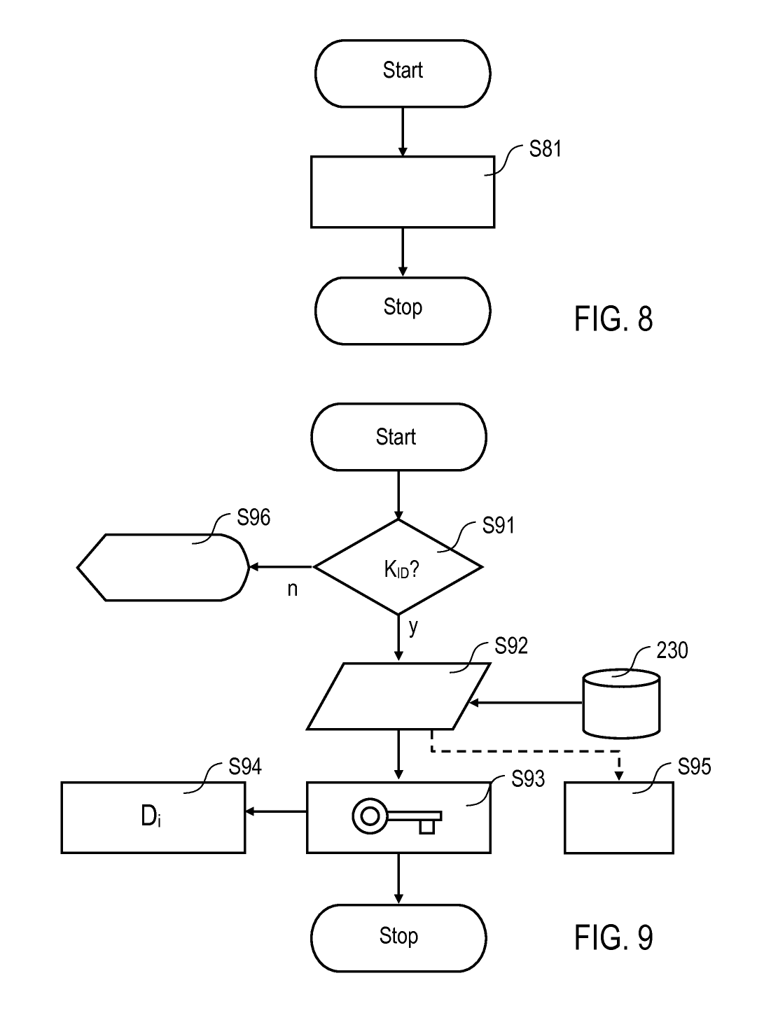

FIGS. 7 and 8: flow diagrams for illustrating a second variant of the method according to the invention and a reversible anonymization of a sample;

FIG. 9: a flow diagram for illustrating a re-identification in the variant in accordance with FIG. 7;

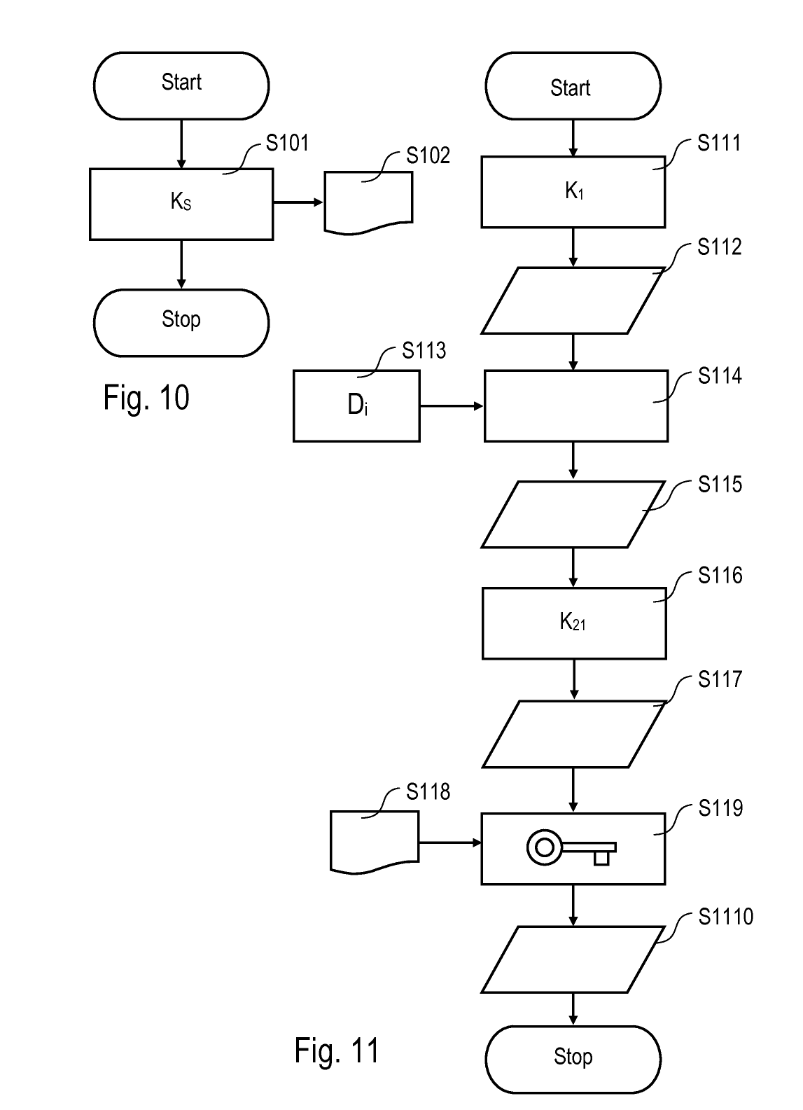

FIGS. 10 and 11: flow diagrams for illustrating a third variant of the method according to the invention;

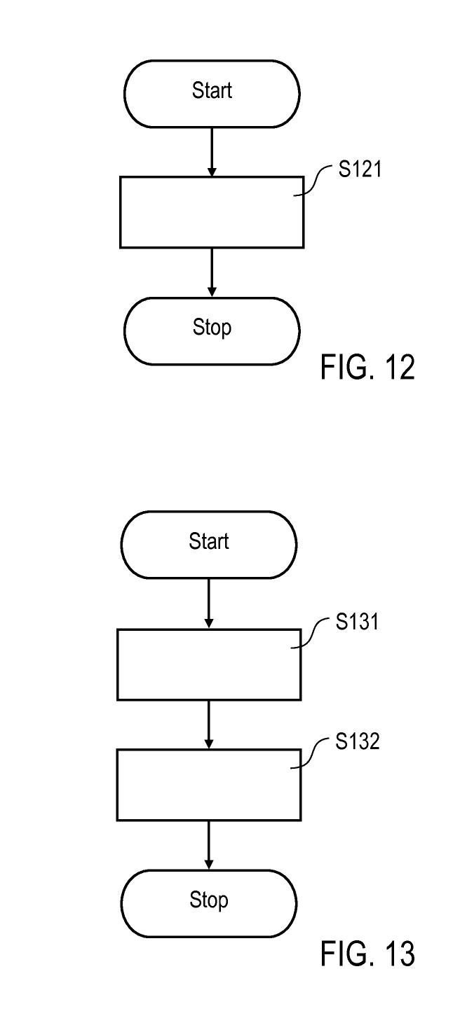

FIGS. 12 and 13: flow diagrams for illustrating a reversible and an irreversible anonymization of a sample in the method in accordance with FIG. 11; and

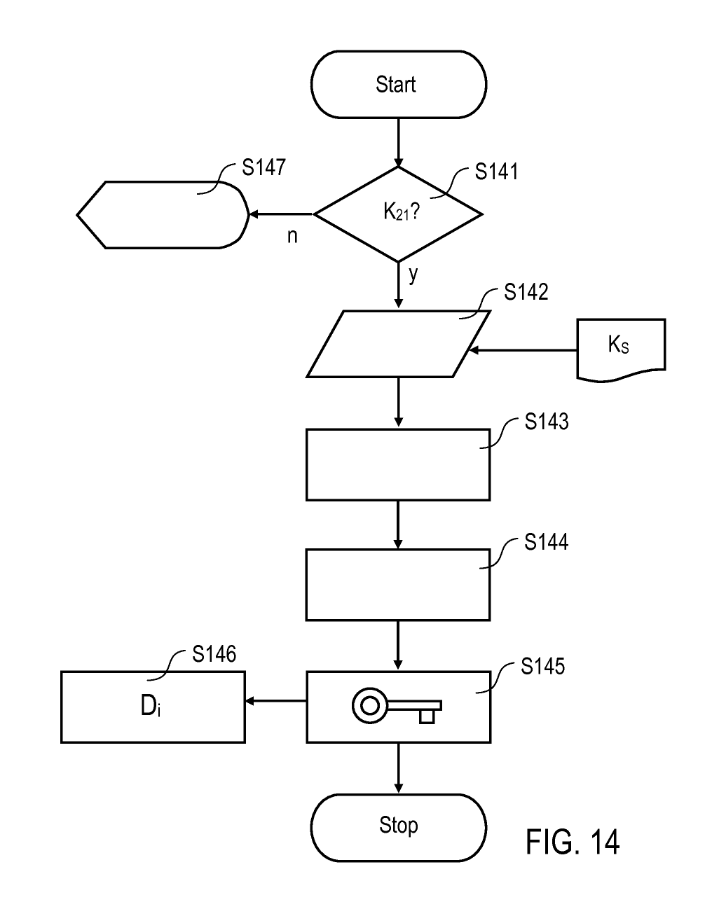

FIG. 14: a flow diagram for illustrating the re-identification in the method in accordance with FIG. 11.

Preferred embodiments of the invention will be described in the following with exemplary reference to the handling of biological samples and accosiated sample data when taking, treating and storing, in particular cryopreservation of the biological samples. It is emphasized that the implementation of the invention is not limited to the application with biological samples, but is also accordingly possible with other samples, e.g. chemical samples or work pieces. The taking, handling and cryopreservation of biological samples are known as such and will thus not be described individually here. Likewise, sample carrier devices for combined reception of at least one sample and sample data are known, so their individual features are not described here.

In the following, first, with reference to FIGS. 1 to 3, features of preferred embodiments of a sample carrier device and data processing device according to the invention are described. Then, with reference to FIGS. 4 to 14, details of the methods for data processing according to the invention, in particular for encrypting or decrypting sample data, are described.
1. Preferred Embodiments of Sample Carrier and Data Processing Devices According to the Invention

FIG. 1 schematically illustrates a first embodiment of a sample carrier device 100 according to the invention, a first embodiment of the data processing device 200 according to the invention and the combination thereof. In the practical use of the invention, a plurality of sample carrier devices 100 are provided for receiving biological samples which can be coupled with one or more data processing devices 200, e.g. in an area 300 of the sample generation or an area 400 of the sample preservation (see FIG. 3).

The sample carrier device 100 comprises the sample receiving device 10 and the data storage device 20, which are permanently connected to each other. The sample receiving device 10 is a closable container, e.g. a sample tube with a lid 11, wherein the data storage device 20 is permanently connected to the bottom of the sample receiving device 10.

The data storage device 20 can alternatively be connected releasably to the container, e.g. screwed or clipped on. The latter can be an advantage for adapter solutions in which a standard container is used as a sample receiving device 10 that is placed in a holder on to which a socket with the data storage device 20 is screwed, for example. The sample tube can be made of a plastic, e.g. polypropylene, in an injection moulding process, wherein in case of a permanent connection the data storage device 20 is connected to the bottom of the sample tube using injection moulding. The sample receiving device 10 contains a sample space with dimensions of e.g. 5 mm diameter and 10 mm height. Alternatively, several separate sample spaces can be provided.

The data storage device 20 comprises a digital storage chip, e.g. a FLASH-EEPROM (FLASH memory) with an interface 21 via which the data connection can be established using the data processing device 200.

In addition to the data storage device 20, the sample carrier device 100 comprises a separate key storage device 30 with several key storages 31, 32. In the example illustrated, on the outside of the sample carrier device 100 or embedded in the outer wall thereof, transponders 37, 38 are provided the transponder storages of which provide the key storages 31, 32 and which are each equipped with a resonant circuit 34, 35. The transponders 37, 38 have e.g. a rod shape as is known from transponder type HITAG 5256, manufactured by NXP (Netherlands). On the transponder 38, a schematic example of an optical marking 38.1 is illustrated which can be used to visually or optically determine whether there is a transponder 38 on the sample carrier device 100. Optical markings can also be provided on the other transponders.

The transponders 37, 38 are connected with the outside of the sample carrier device 100, e.g. made of plastic. For example, a glued connection, a plastic connection between a plastic sheating of the transponders and the sample carrier device 100 can be established e.g. with an injection moulding process, or a storage holder which is designed for a plug, locking or screw connection can be provided. By using the glued or plastic connection, preferably a predetermined breaking point 12 is created between the transponders 37, 38 and the sample carrier device 100 which is illustrated schematically in FIG. 1A and which serves for the irreversible removal of one transponder each or at least the associated key storage from the sample carrier device 100. The removal of at least one key storage from the sample carrier device 100 allows for an irreversible or reversible anonymization as described in further detail below.

Due to their different functions, the data storage device and the key storage device typically have different storage capacities, which are selected for the at least one data storage in the range of e.g. 512 kbits to 16 Mbits and for the at least one key storage in the range of e.g. 128 bits to 256 bits. These values represent examples which can vary depending on the concrete application of the invention and the encrypting requirements. Thus, a minimum size for the data storage can be viewed in general by a block size (N value) which often corresponds with the key length in a symmetrical process. The size of the data storage can exceed said interval when using suitable storage chips. For the key storage, the limit of 128 bits can be considered the minimum for symmetrical methods, whereas 2048 bits is currently considered the minimum for asymmetrical methods (e.g. RSA). Currently, keys of up to 512 bits are possible for the CAST encryption, and up tot 4096 bits for the RSA method. However, these limits, in particular with the further technical development, can be expanded upward.

The data processing device 200 comprises a read-write device 210, a cryptological processor 220 and optionally, a computing device 250 such as a computer. Deviating from the illustration, the cryptological processor 220 can be provided as a part of the computing device 250. The cryptological processor 220 can particularly be realized by a software program that is run in the computing device 250.

The read-write device 210 is configured and/or is controlled by the components 220 or 250 to read key data that is stored in the key storages 31, 32 and/or to save key data in the key storages 31, 32. The cryptological processor 220 is connected to the read-write device 220 and equipped with an interface 221 for a data connection with the data storage device 20 of a data processing device 200 coupled with the sample carrier device 100. The cryptological processor 220 is configured for decrypting and/or encrypting sample data or key data. The computing device 250 can be used to control the read-write device 210 and/or the cryptological processor 220 and/or for additional data processing.

In the example illustrated, in which the key storages 31, 32 are designed for wireless communication with the data processing device 200, the read-write device 210 contains a schematically illustrated antenna 211 with which the transponders 37, 38 can be accessed individually or together. The read-write device 210 is configured for a data connection with the transponders 37, 38 as is known from conventional transponder or RFID technologies. When operating the antenna 211, in particular key data can be read from the key storages 31, 32. The read-write device 220 can also be designed to write data into the key storages 31, 32 such as e.g. for initial storage of a cryptological key or to change keys.

Deviating from the illustration, wired communication can be provided between the key storage device 30 and the data processing device 200. In addition, a wired or wireless data connection can be provided between the key storage device 30 and the data storage device 20.

FIG. 2 schematically illustrates features of modified embodiments of the sample carrier device 100 according to the invention, and the data processing device 200 according to the invention and their mutual combination. According to FIG. 2, the sample carrier device 100 in accordance with the example of FIG. 1 comprises a sample receiving device 10, a data storage device 20 and a key storage device 30. In the example illustrated, the key storage device 30 comprises three transponders 37, 38 and 39, whose transponder storages each provide one of the key storages 31, 32 and 33. The transponders 37, 38 and 39 are permanently connected to the sample carrier device 100 or releasably using a predetermined breaking point or a storage holder, as in the example of FIG. 1.

The data processing device 200 comprises a read-write device 210, a cryptological processor 220 and a key database 230. In addition, as in the example of FIG. 1, an optional computing device 250, e.g. a computer, is provided which is connected to the other components of the data processing device 200.

The example of FIG. 2 is configured for a reversible anonymization of the sample data using an identification key and/or a master key.

According to the first variant, the cryptological key for encrypting the sample data is stored in the key storage 31 of the first transponder 37 while the key storage 32 of the second transponder 38 contains an identification key. The cryptological key is also stored in the key database 230. The information is stored using a certain storage position or using another unique identification, wherein the identification key contained in the key storage 32 references the storage location or the other identification of the cryptological key stored in the key database 230. In this variant, by removing the first transponder 37, a reversible anonymization can be achieved and by using the identification key in the second transponder 38, a re-identification and when also removing the second transponder 38, an irreversible anonymization of the sample data can be achieved as described in more detail below (see FIGS. 7 to 9).

According to the second variant, a part of a master key is stored in the key storage 33 of the third transponder 39 while a further part of the master key is stored in a source database 310. The cryptological key is stored in the key storage 31 of the first transponder 37 and, using the master key, comprising both aforementioned parts, encrypted in the data storage device 20. By reading the part of the master key stored in the key storage 33 with the read-write device 210 and the combination of this part of the master key with the other part from the source database 310, the master key is generated with which the encrypted cryptological key stored in the data storage device 20 can be decrypted. In the second variant, it can thus be provided a reversible anonymization by removing the first transponder 37 with the cryptological key, and a re-identification using the master key, and a final, irreversible anonymization can be achieved by removing the third transponder 39. The re-identification is possible in the example illustrated using the second part of the master key only by coupling the data processing device 200 with the source data storage 310, e.g. at the site where the sample was generated. The two variants with a re-identification using the identification key or the master key can furthermore be combined.

If, alternatively, a method without the source data storage 300 were provided in which the complete master key is contained in the key storage 33 of the third transponder 39, additionally a password or the like would be required to achieve anonymization.

FIG. 3 schematically illustrates the application of the invention when taking, storing and further handling biological samples. First, a sample and associated sample data will be saved in a sample carrier device 100 in an area 300 of the sample generation. A sample is taken using a commonly known laboratory method, such as e. g. blood sampling or a biopsy from a sample donor, and the transfer of the sample into the sample receiving device 10. With a data processing device 200, e.g. in accordance with FIG. 1 or 2, sample data are stored in the data storage device 20 of the sample carrier device 100. When first receiving samples, the generation and storage of the cryptological key for encrypting the sample data can be provided (see FIG. 4). Then, the sample carrier device 100 can be stored in an area 400 for preserving the sample. Provided is, for example, a cryopreservation device 410, e.g. a tank, in which the sample carrier device 100 can be cooled down to a temperature of the liquid nitrogen or the vapor of liquid nitrogen. Depending on the concrete application of the invention, after a storage period, the transfer of the sample carrier device 100 to an area 500 for sample processing with one or several work stations can be provided. In area 500, the sample can be reversibly anonymized by removing a first key storage with the cryptological key (left in area 500) or irreversibly anonymized by removing all key storages (right in area 500). In addition, in area 500, using a data processing device 200, it is possible to read and/or complement sample data.
2. Preferred Embodiments of the Methods According to the Invention for Processing Sample Data

The generation of the cryptological key, storage of the cryptological key in the key storage device 30 and the encrypting of the sample data is illustrated schematically in FIG. 4.

The generation of a concretely applied cryptological key, e.g. in the data processing device 200, initially is based on the provision of a encryption system KRYPTO with encrypting functions f_{Ki} for a key Kᵢ, optionally with encrypting parameters N₁, . . . Nₙ. The encryption system KRYPTO is preferably a per se known standard encryption system as known from technical literature. It can be based on a symmetrical algorithm (secret key algorithm), e.g. the encryption systems DES, AES and CAST, or on an asymmetrical algorithm. The encryption system and the parameters Nᵢ are selected so that the resulting key space contains P keys (preferably exclusively) that can be stored in the key storage. The key resulting from the encryption system KRYPTO is stored in the key storage of the key storage device 30. Typically, based on the encryption system used, the P keys available in key space and, if applicable, the parameters Nᵢ, a key Kᵢ to be used is defined that is stored in the key storage device 30 and supplied to the cryptological processor 220 (see FIGS. 1, 2). Typically, the generation of the cryptological key Kᵢ is provided at the site of the sample generation e.g. in area 300 (see FIG. 3). The generation of the cryptological key Kᵢ is preferably random, i.e. based on a random selection.

When writing the sample data Dᵢ into the data storage device the sample data Dᵢ is subject to encryption in the cryptological processor with the key Kᵢ, so that the encrypted (secret) sample data f_{Ki}(Dᵢ) is generated.

If several sample data types D₁, . . . Dₙ to be encrypted separately, e.g., different information within the sample data are provided, the scheme in accordance with FIG. 4 is modified so that for each sample data type, a separate cryptological key K₁, . . . Kₙ is generated and stored in the corresponding key storage and used for encoding the corresponding sample data types D₁, . . . , Dₙ.

The parameters Nᵢ can be required for decrypting sample data and stored in a clear text area (clear text header) in the data storage device 20.

Due to the short key lengths (≦256 bits currently, e.g. 128, 192 or 256 bits, storage capacity of small transponders is usually very limited) and comparatively high attack security in comparison to short keys in asymmetrical systems, the encryption system KRYPTO is preferably based on a block cipher (block encryption). In a concrete example, the block cipher CAST with a block length/key length of 128 bits is used. CAST-128 is defined in RFC 2144 (http://www.faqs.org/rfcs/rfc2144.html), CAST-256 in RFC 2612 (http://tools.ietf.org/html/rfc2612). The known AES cipher (Rijndeal) or Twofish also belong to the block ciphers. Alternatively, other systems can be used, thus, with the help of public/private key systems, scenarios can be realized in which certain stations can only write data (using the public key) and other stations can read and write (reading requires the private key).

FIGS. 5 and 6 illustrate an embodiment of the method according to the invention with an irreversible anonymization (one-way anonymization). According to FIG. 5, the generation of the cryptological key (step S51) and storing the cryptological key, e.g. in the key storage 31 (transponder storage) of a first transponder 37 in FIG. 1 (step S52), is carries out firstly. Steps S51 and S52 are typically provided once, e.g. during the initial reception of a sample in the sample carrier device. Depending on the application of the invention, steps S51 and S52 can, however, be repeated during further processing of the sample. It can also be provided for that at least one additional cryptological key is generated in addition to a first cryptological key that is generated during the original entry of the sample, e.g. for predetermined sample data types.

After providing the sample data Dᵢ to be stored (step S53), the encryption of the sample data is performed in the cryptological processor 220 (see FIGS. 1, 2) (step S54). Then, the encrypted sample data is stored in the data storage device (step S55). As a result, the at least one cryptological key is available in the key storage device and the encrypted sample data in the data storage device of the sample carrier device according to the invention.

To irreversibly anonymize the sample, by permanently preventing future access to certain sample data types, in particular person-related data, the key storage 31 with the cryptological key is removed from the sample carrier device 100 in accordance with FIG. 6 (step S61). For example, the first transponder 37 which contains the cryptological key is broken from the sample carrier device 100 (see FIG. 1A). Without the transponder 37, the cryptological key can no longer be read by the data processing device 200 so the sample data in the data storage device 20 can no longer be decrypted. The sample is thus anonymized if it is transferred without the first transponder 37.

Features of a modified embodiment of the method according to the invention for which a reversible anonymization of the sample is provided are illustrated in FIGS. 7 to 9.

According to FIG. 7, a cryptological key is first generated (step S71) that is stored in the key storage 31 (transponder storage) of the first transponder 37 in FIG. 1 (step S72) and in a key database 230 (see FIG. 2) (step S73). Data that allows the cryptological key to be unambiguously read from the key database 230 and is designated as an identification key is read from the key database 230 (or generated when the key is generated) and stored in the key storage 32 (transponder storage) of the second transponder 38 (see e.g. FIG. 1) (step S74). For example, a continuous line index (generated by the database) or an internal identifier is used as an identification key, which is then also generated by the data processing device 200 and stored in the key database 230. The identification key comprises, e.g. the information about the storage location of the cryptological key in the key database 230. As a result, the cryptological key is stored in the first transponder 37 and the identification key is stored in the second transponder 38.

Subsequently, the sample data provided in step S75 is encrypted (step S76) and stored as encrypted data in the data storage device 20 of the sample carrier device 100 (see FIG. 1) (step S77).

With the method in accordance with FIG. 7, the sample can be reversibly anonymized and re-identified as illustrated in FIGS. 8 and 9. The reversible anonymization first comprises the removal of the cryptological key from the sample carrier device 100. To this end, in accordance with step S81, the first transponder 37 in the storage of which the cryptological key is stored, is separated from the sample carrier device 100 (see FIG. 1A). As a result, the sample data stored in the data storage device 20, in particular person-related data, can no longer be encrypted so that the samples can no longer be assigned to a certain donor.

If a re-identification of the sample is required, e.g. to add data about the donor, in accordance with FIG. 9, after a test as to whether the identification key is available in the sample carrier device 100 (step S91), the cryptological key can be read from the key database 230 using the identification key (step S92). After this, sample data that is encrypted with the cryptological key and stored in the data storage device 20 can be read (step S93), so that the decrypted sample data are provided (step S94).

The method according to FIG. 9 correspondingly can be used to query the cryptological key from the key database 230 and for encrypting additional sample data that is to be stored encrypted in the data storage device 20. In addition, optionally, after step S92, the cryptological key read from the key database 230 can be stored in a further key storage device provided at the sample carrier device 100 (step S95), in order to be available for additional encryption or decryption processes.

The method according to FIG. 9 can only be carried out if there is data communication with the key database 230. To ensure that the re-identification is only performed at the site where the key database is physically available, e.g. in a laboratory or a hospital, it is preferred for the data processing device 200 according to the invention that the key database 230 is arranged within the data processing device 200 and connected electrically with the read-write device 210 and/or the cryptological processor 220.

A final anonymization (irreversible anonymization) can be realized in the method in accordance with FIG. 7 in such a way that both the cryptological key and the identification key are removed from the sample carrier device 100. For example, both transponders 37 and 38, which each contain the cryptological key and the identification key can be broken from the sample carrier device 100. In this case, the test at step S91 in FIG. 9 yields a negative result so that a re-identification (de-anonymization) is not possible (step S96).

The use of the identification key in accordance with FIGS. 7 to 9 can be modified so that it is not the original cryptological key, but a modified cryptological key that is stored in the key database 230. The modified cryptological key can be read using the identification key from the key database 230 and used to decrypt sample data that is to be saved thereafter in the data storage device 20.

Features of a further embodiment of the method according to the invention while using the master key are illustrated in FIGS. 10 to 14. In the illustration, the assumption is made that the master key is composed of two partial keys, namely the source partial key and the sample partial key which can only be used together, e.g. at the site where the sample was generated (e.g. area 300 in FIG. 3). Alternatively, a unitary master key can be used that is exclusively available at the site where the sample was generated.

FIG. 10 illustrates the generation of the source partial key K_{S} in area 300 of the generation of the sample (step 5101) and storage of the source partial key K_{S} in the data processing device 200 (step S102). It should be mentioned that in particular with symmetrical methods for generating a partial key, a new partial key K_{S} does not have to be generated every time. For instance, when using block ciphers, K_{S} there can simply be a 64 bit key while the sample partial key can then be any other 64 bit key. For encryption and decryption, both are then combined, e.g. arranged one after the other (see also FIG. 11), to make a 128 bit key.

According to FIG. 11, with the first steps, the generation of the cryptological key K₁ (step S111), the storage of the cryptological key K₁ (step S112) on the first transponder 37 (see FIG. 1), the provision of the sample data Dᵢ to be secured (step S113), its encryption (step S114) and its storage (step S115) in the data storage device 20 are shown. These steps are realized like steps S51 to S55 in FIG. 5.

In a further sequence of steps, the generation of the sample partial key K₂₁ is provided (step S116), which is stored in the second transponder 38 (step S117). After providing the source partial key K_{S} (step S118) the cryptological key is encrypted K₁ with a master key p₂, which is composed of the sample partial key K₂₁ and the source partial key K_{S} (step S119). The encrypted cryptological key K₁ is stored in the data storage device 20 of the sample carrier device 100 (step S1110). As a result, the encrypted sample data (from step S114) and the encrypted cryptological key K₁ (from step 51110) are stored in the data storage device 20.

A reversible anonymization of the sample is achieved by removing the first transponder 37 with the cryptological key from the sample carrier device in accordance with FIG. 12 (step S121). If, however, both the first transponder 37 and the second transponder 38 accordingly with the cryptological key K₁ and the sample partial key K₂₁ are separated from the sample carrier device 100 (step S131 and S132 in FIG. 13), the sample is irreversibly anonymized. By removing the sample partial key K₂₁, the encrypted cryptological key stored in the data storage device cannot be decrypted later so that the encrypted sample data can no longer be encrypted.

FIG. 14 illustrates the re-identification (de-anonymization) of the sample when using the master key. First, a verification is made whether the sample partial key K₂₁ is available on the sample carrier device 100 (step S141). Then, the sample partial key K₂₁ is completed by the source partial key K_{S} (step S142). After reading the encrypted cryptological key K₁ from the data storage device (step S143), it is decrypted with the master key from step S142 so that the original cryptological key is obtained (step S144). Herewith, the sample data from the data storage device 20 is decrypted (step S145) and made available as decrypted sample data (step S146).

If the sample partial key K₂₁ has been removed from the sample carrier device 100, the test in step S141 has a negative result so that de-anonymization is excluded (S147).

If the master key uniformly exclusively consists of the source partial key, generating the master key as in step S142 can be omitted. In this case, the encrypted cryptological key is decrypted at the location of the source partial key, e.g. in the area of the sample generation (see FIG. 3).

The aforementioned methods can refer to the entire sample data or a part of it, in particular certain sample data types. In addition, the methods can be realized with several cryptological keys which are based on different data areas in the data storage device 20 that are to be protected.

In summary, the advantages of the invention can be seen in the fact that the supplementation of a sample carrier device with a key-based authentication, in particular with transponders, allows a number of applications when generating and handling samples, in particular biological samples. The anonymization of the samples represents a per se complex process that, according to the invention, can be realized by a single, simple step, e.g interrupting the transponder from the sample carrier device. By later reassigning the transponder to the sample carrier device or using a reversible concept, however, access to the data can be restored if necessary.

The features of the invention disclosed in the previous description, the drawings and the claims can be significant individually as well as in combination for the realization of the invention in its different embodiments.

1-23. (canceled)

24. A sample carrier device, comprising:
a sample receiving device, which is adapted for receiving at least one sample,
a data storage device, which is adapted for storing sample data, which relate to the at least one sample, and
a key storage device with at least one key storage, in which the key storage device is adapted for storage of key data in the at least one key storage.

25. The sample carrier device according to claim 24, which is adapted for receiving biological samples.

26. The sample carrier device according to claim 24, wherein at least one key storage of the key storage device is separable from the sample carrier device.

27. The sample carrier device according to claim 24, wherein the at least one key storage is adapted for at least one of electronic, optical and magnetic storage of the key data.

28. The sample carrier device according to claim 24, wherein the key storage device is adapted for wireless communication with a data processing device.

29. The sample carrier device according to claim 24, wherein the key storage device comprises at least one transponder.

30. The sample carrier device according to claim 24, wherein
the data storage device is adapted for storage of different data types, and
the key storage device comprises a plurality of key storages, which are adapted for storage of respectively different key data for respectively one of the data types.

31. The sample carrier device according to claim 30, wherein
the data storage device comprises a plurality of storage areas, which are adapted for storage of respectively one of the data types, and
each of the key storages is assigned to one of the storage areas, respectively.

32. The sample carrier device according to claim 24, wherein each key storage of the key storage device carries a specific mark.

33. The sample carrier device according to claim 32, wherein the specific mark is an optical mark.

34. A data processing device, which is adapted for coupling with one sample carrier device according to claim 24, comprising:
a read-write device for at least one of writing and reading the key data into or out of the key storage device of the sample carrier device, and
a cryptologic processor, which is connected to the read-write device and is adapted for at least one of decryption and encryption of sample data.

35. The data processing device according to claim 34, which comprises a key database, which is adapted for storage of the key data.

36. A method for processing sample data, wherein the sample carrier device according to claim 24 is used, comprising the steps:
encryption of the sample data with at least one cryptologic key, which is saved in the key storage device, and
storage of the encrypted sample data in the data storage device of the sample carrier device.

37. The method according to claim 36, further comprising the steps:
encryption of different data types of the sample data with, respectively, different cryptologic keys, and
storage of the encrypted, different data types of the sample data in the data storage device.

38. The method according to claim 36, further comprising the steps:
storage of the at least one cryptologic key in the key storage device and additionally in a key database, and
storage of at least one identification key in the key storage device, which identifies the at least one cryptologic key in the key database, wherein
the at least one cryptologic key and the at least one identification key are saved in different key storages of the key storage device.

39. The method according to claim 38, further comprising the steps:
reading of the at least one cryptologic key from the key storage device or from the key database, and
decryption and reading of the encrypted sample data saved.

40. The method according to claim 36, further comprising the steps:
encryption of the at least one cryptologic key with a master key, and
storage of the at least one encrypted cryptologic key in the data storage device.

41. The method according to claim 40, further comprising the step of storage of at most a part of the master key in the key storage device.

42. The method according to claim 40, further comprising the step of storage of at least one part of the master key in a source storage, which is provided for in a region of generation of the sample.

43. The method according to claim 40, further comprising the steps:
reading of the at least one encrypted cryptologic key from the data storage device,
decryption of the at least one encrypted cryptologic key with the master key, and
decryption and reading of the encrypted sample data saved.

44. The method according to claim 36, further comprising the step of anonymization of the saved encrypted sample data by separating a key storage, in which the cryptologic key is saved, from the sample carrier device.

45. The method according to claim 36, further comprising the step of anonymization of the saved encrypted sample data by separating at least one key storage, in which at least one of the identification key and the part of the master key is saved, from the sample carrier device.

46. The method according to claim 36, further comprising the step of wireless transmission of at least one of the cryptologic key, the identification key and the master key from the key storage device to a reading device, which is provided for reading the key data.

47. A method for authentication of a sample carrier device according to claim 24, further comprising the steps:
coupling the sample carrier device with a reading apparatus of a workstation in a region for sample processing,
read-out of the key data from the sample carrier device with the reading apparatus, and
establishing the identity of at least one of the sample carrier device and the workstation using the key data.

48. The method according to claim 47, wherein the key data comprise a signature key, wherein a sample source signs the sample in a region of sample generation with a private key that is known only to the sample source and the signature can be verified with a public key.
